(19) United States
(12) Patent Application Publication
(10) Pub. No.: US 2006/0232862 A1
(43) Pub. Date: Oct. 19, 2006

(54) Dual mode optical magnification system

(75) Inventors: David Paul Steven, Edinburgh (GB); Jeffrey Peter Wright, Edinburgh (GB); Ian Underwood, Edinburgh (GB)

Correspondence Address: HOWSON AND HOWSON, SUITE 210, 501 OFFICE CENTER DRIVE, FT WASHINGTON, PA, 19034, US

(73) Assignee: MicroEmissive Displays Limited, Edinburgh (GB)

(21) Appl. No.: 10/535,678

(22) PCT Filed: Nov. 17, 2003
(86) PCT No.: PCT/GB03/04971

§ 371 Date: Jun. 5, 2006

(30) Foreign Application Priority Data
Nov. 20, 2002 (GB) 0227119.5

(51) Int. Cl. G02B 27/28

(52) U.S. Cl. 359/501; 359/483

(57) ABSTRACT

An image-forming system, for example for a camcorder or digital still camera, comprises an object (1), such as a display, a multi-element magnifying optical path (8) and focal length varying means for addition, adjustment or removal of one or more elements (9) in the optical path in order to vary the distance between a viewer's eye and the system, at which distance the magnified object can be viewed.

### BACKGROUND OF THE INVENTION

This patent invention relates to an optical magnification system.

Almost all camcorders and digital still cameras (DSC's) contain a direct-view miniature flat screen, of around 20 mm to 50 mm in size, to aid with picture taking and review. This screen is typically viewed from a distance of 25 cm to 40 cm—“arm's length”. Almost all camcorders and some DSC's also contain an electronic viewfinder (EVF) consisting of a much smaller liquid crystal display (LCD) or cathode ray tube (CRT) screen behind a magnifying optic. The EVF is typically viewed by holding the optic dose to the eye—“near-to-eye”.

Desirable characteristics of the direct view screen include:
(1) The display is of a sufficient size that the user can view it comfortably at a normal reading distance of 25-40 cm.
(2) The display has a resolution that is high enough to provide images of video or picture quality.
(3) The amount of electrical current used by the display is minimized, therefore increasing battery life.
(4) The display is bright enough to be visible in normal sunlit conditions

Desirable characteristics of the EVF include:
(1) The image of the display is of sufficient size and distance that the user can view it comfortably, with minimum eye strain
(2) The display has a resolution that is high enough to provide images of video or picture quality and is without any pixelation, which may be to the detriment of the video or picture.
(3) The display is bright enough to be viewed through a viewfinder eyepiece with little or no extraneous light.

### SUMMARY OF THE INVENTION

It is an aim of the invention to provide a magnification system which can be switched between two modes of use, namely “near-to-eye” and “arm's-length”. This has the advantage of offering both types of viewing capability using a single viewing system.

Accordingly, the present invention provides an image-forming system comprising an object, a multi-element magnifying optical path and focal length varying means for addition, adjustment or removal of one or more elements in the optical path in order to vary the distance between a viewer's eye and the system, at which distance the magnified object can be viewed.

The focal length varying means may comprise means for moving one or more optical elements, such as a flat aspherical fresnel lens into and out of the optical path. Alternatively, the focal length varying means may comprise an electro-optical element such as a liquid crystal lens or programmable diffractive element.

The object may be emissive or reflective.

In one embodiment, a polarizer is located between the object and the optical path. Alternatively or additionally, for increased efficiency, the object may be arranged to emit polarized light.

The optical path may comprise, in order, a curved beamsplitter, a first quarter wave plate, a planar beamsplitter, a second quarter-wave plate and a linear polarizer. The curved beamsplitter may be replaced by a holographic analogue thereof.

Light emitted from the object may be collimated, thereby allowing greater collection of the initial emitted light rays, and allowing more control over the initial emitted light rays.

### BRIEF DESCRIPTION OF THE DRAWINGS

Embodiments of the present invention will now be described in more detail, by way of example only, with reference to the accompanying drawings, in which:

FIG. 1 is a schematic sectional view of a magnification system according to the invention;

FIG. 2 is a generalized schematic view of the system of FIG. 1, configured as an “arm's length” viewer; and

FIG. 3 is a generalized schematic view of the system of FIG. 1, configured as a “near-to-eye” viewer.

### DETAILED DESCRIPTION OF THE PREFERRED EMBODIMENTS

The present invention comprises an object, a device for magnifying the image of the object and an optical device that can be used to shorten the focal length of the overall device therefore making it useful as a near-to-eye display.

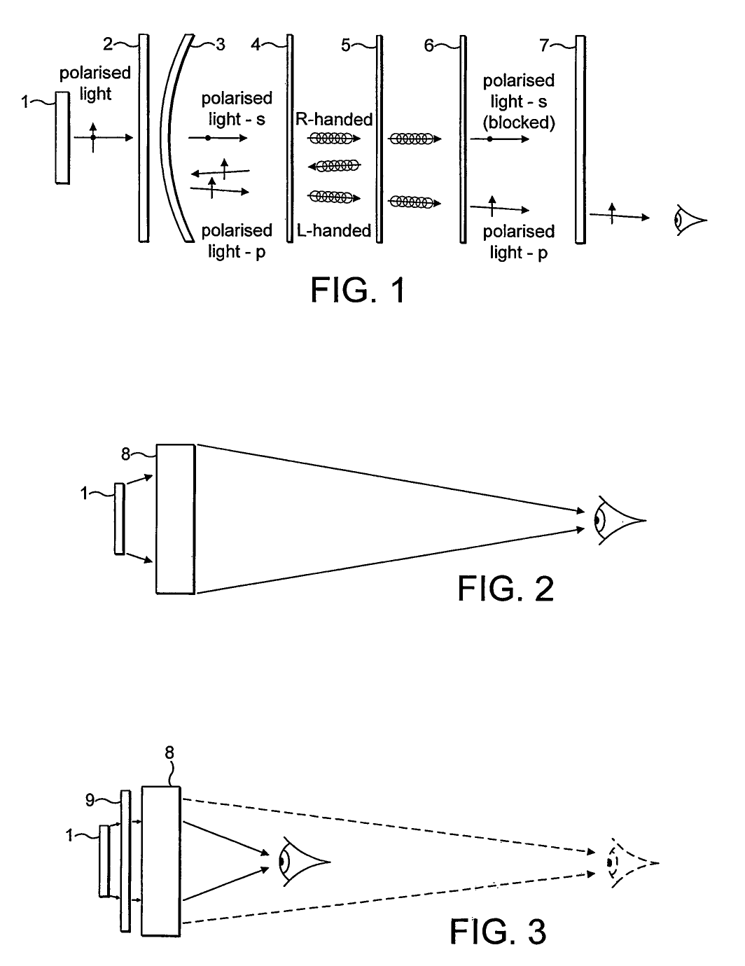

As shown in FIG. 1, the device used for magnifying the image is based on the ‘pancake window™’ as described in U.S. RE 27,356. The principle of operation of this depends on the light from the object, in this case a display 1, being polarized by a linear polarizer 2 before it enters the optical device. On entering the device, the polarized light passes through a curved beamsplitter 3, then through a quarter wave plate 4, which has its optical axis at 45° to the direction of the polarization. This converts the linearly polarized light into circularly polarized light. This is then passed through a planar beamsplitter 5, which passes 50% of the light and reflects back the other 50% of the light This reflected light has its polarization state reversed on reflection and is now passed through the quarter wave plate 4 in the opposite direction. On this pass through the quarter wave plate the light is converted back to linearly polarized light with its direction of polarization orthogonal to that of the incoming light. The light now strikes the curved beamsplitter 3 again and 50% is reflected back through the system. This light again passes through the quarter wave plate 4, this time being converted to circularly polarized light with the opposite handedness of the light that passed through initially. Again this strikes the planar beamsplitter 5 and 50% is passed through onto the next element in the system. The next element is another quarter wave plate 6 that converts the circularly polarized light back to linear polarized light, but with the polarization direction orthogonal to that of the direction of the light which initially entered the system. The final element in the system is a linear polarizer 7, which is positioned such that it allows this light to pass through. The light which first passed through the curved beamsplitter 3 is polarized in the opposite direction and is blocked by the linear polarizer.

The amount of magnification is determined by the radius of curvature of the curved beamsplitter 3.

This device can be used to magnify the object for use as an arm's length viewer as shown in FIG. 2, in which the magnification device is designated by 8. In order to switch the device into a mode that can be used as a near-to-eye viewer a lens 9, shown in FIG. 3, or other optical element or elements, must be placed between the object 1 and the magnification device 8 in order to reduce the focal length of the system. This could be a flat aspherical fresnel lens which could be mechanically switched in and out of the device depending on which mode the operator wished to use it in, or it may be some electro-optic element such as a liquid crystal lens or programmable diffractive element.

All forms of the verb “to comprise” used in this specification have the meaning “to consist of or include”.

1. An image-forming system comprising an object, a multi-element magnifying optical path and focal length varying means for addition, adjustment or removal of one or more elements in the optical path in order to vary the distance between a viewer's eye and the system, at which distance the magnified object can be viewed.

2. A system according to claim 1, wherein the focal length varying means comprises means for moving one or more optical elements, into and out of the optical path.

3. A system according to claim 2, wherein the focal length varying means comprises means for moving a flat aspherical fresnel lens into and out of the optical path.

4. A system according to claim 1, wherein the focal length varying means comprises an electro-optical element.

5. A system according to claim 4, wherein the electro-optical element comprises a liquid crystal lens.

6. A system according to claim 4, wherein the electro-optical element comprises a programmable diffractive element.

7-13. (canceled)

14. A system according to claim 1, wherein the object is light-emissive.

15. A system according to claim 14, wherein the object is arranged to emit polarized light.

16. A system according to claim 1, wherein the object is light-reflective.

17. A system according to claim 1, wherein a polarizer is located between the object and the optical path.

18. A system according to claim 1, wherein the optical path comprises, in order, a curved beamsplitter, a first quarter wave plate, a planar beamsplitter, a second quarter-wave plate and a linear polarizer.

19. A system according to claim 1, wherein the optical path comprises, in order, a holographic analogue of a curved beamsplitter, a first quarter wave plate, a planar beamsplitter, a second quarter-wave plate and a linear polarizer.

20. A system according to claim 1, wherein light emitted from the object is collimated.

21. A system according to claim 3, wherein the object is light-emissive and arranged to emit polarized light.

22. A system according to claim 3, wherein the object is light-reflective.

23. A system according to claim 3, wherein a polarizer is located between the object and the optical path.

24. A system according to claim 3, wherein the optical path comprises, in order, a curved beamsplitter or a holographic analogue of a curved beamsplitter, a first quarter wave plate, a planar beamsplitter, a second quarter-wave plate and a linear polarizer.

25. A system according to claim 4, wherein the object is light-emissive and arranged to emit polarized light.

26. A system according to claim 4, wherein the object is light-reflective.

27. A system according to claim 4, wherein the optical path comprises, in order, a curved beamsplitter or a holographic analogue of a curved beamsplitter, a first quarter wave plate, a planar beamsplitter, a second quarter-wave plate and a linear polarizer.
